(19) United States
(12) Patent Application Publication
(10) Pub. No.: US 2015/0095055 A1
(43) Pub. Date: Apr. 2, 2015

(54) METHODS FOR PROCESSING A PRESCRIPTION DRUG REQUEST

(71) Applicant: Horizon Pharma USA, Inc., Deerfield, IL (US)

(72) Inventor: Jeffrey T. Bagull, Hinsdale, IL (US)

(21) Appl. No.: 14/501,778

(22) Filed: Sep. 30, 2014

Related U.S. Application Data
(60) Provisional application No. 61/884,710, filed on Sep. 30, 2013.

(51) Int. Cl. G06F 19/00; G06Q 30/02

(52) U.S. Cl. CPC G06F 19/328; G06F 19/3456; G06Q 30/0207
USPC 705/2

(57) ABSTRACT

Methods and systems for processing prescription drug requests and patient discounts are disclosed.

### CROSS REFERENCE TO OTHER APPLICATIONS

This application claims the benefit of priority of U.S. provisional application No. 61/884,710 filed Sep. 30, 2013, the disclosure of which is hereby incorporated by reference as if written herein in its entirety.

### BACKGROUND

1. Field

Provided are methods and systems for marketing a prescription drug, more specifically to methods and systems for processing prescription drug requests and patient discounts.

2. Related Art

Conventionally, a medical patient obtains a written script for a prescription drug from a physician to address the patient's malady. The patient carries the written script to a pharmacy. The pharmacy fills the prescription. The patient makes payment and picks-up the prescription drug at the pharmacy. The price paid by the patient is determined by their insurer, less any coupon they may have. Patients without insurance pay the list price plus a pharmacy markup, which is often as high as 20%. The pharmacy collects the covered benefit amount from the insurer.

The patient must either accept or reject the requested drug's price. Thus, individuals may not purchase a needed prescription medicine simply because they cannot afford it—because either they lack insurance, or the insurer refuses to cover the cost. Furthermore, insurers carry substantial buying power, and can often negotiate discounts and rebates for prescribed drugs with pharmaceutical distributors. Insurers and drug distributors may have longstanding business agreements to provide established drugs for insured patients in return for lower pricing, and may refuse to cover the cost of the latest treatments. Thus, even if a patient's doctor has prescribed the new drug, patients often do not purchase the medicine due to the high out-of-pocket cost.

Accordingly, it can be very difficult for pharmaceutical companies to introduce new medicines or promote existing products into the marketplace. Various types of coupons, including discount, special-offer, rebate coupons, and the like, are a common marketing strategy for new products. They can be used to offset the high out-of-pocket costs, and remove price as a barrier to purchasing the drug.

However, coupons are expensive to produce and distribute, and often fail to produce a response in the marketplace. Patients may be reluctant to expend the effort to use coupons. Gathering, storing, and remembering to take a redeemable coupon to a pharmacy are activities with which many patients may not have time to engage.

Additionally, insurance companies commonly require paperwork to be filled out by the physician in order for patients to have access to newer medications. Physician's offices may lack the manpower to fill out this paperwork, which prevents patients from getting medicines.

Thus, there remains a need for improved methods and systems for processing and providing out-of-pocket price discounts for prescription drug requests.

### SUMMARY

Accordingly, provided are methods and systems for processing and providing out-of-pocket price discounts for prescription drug requests.

Provided is a method for processing and providing an out-of-pocket price discount for a prescription drug request for a patient in need thereof, comprising the steps of:
receiving the patient's prescription drug request;
determining the patient's health insurance provider's payment coverage of the prescription drug; wherein:
if payment coverage is approved, providing the prescription drug to the patient at a first price; and
if payment coverage is denied, providing the prescription drug at an alternative price.

Also provided is a non-transitory, machine-readable medium that stores instructions, which when performed by a machine, cause the machine to perform operations comprising the steps of:
receiving a patient's prescription drug request wherein the prescription drug is to be provided to the patient at a first price;
determining if the patient's health insurance provider denies payment coverage of the prescription drug;
   if payment coverage is approved, providing the prescription drug to the patient at that first price; and
   if payment coverage is denied, provide the prescription drug at an alternative price.

Also provided is a system for processing and providing an out-of-pocket price discount for a prescription drug request for a patient in need thereof, comprising:
an interface for receiving the patient's prescription drug request;
one or more databases having formulary data for one or more health insurance providers;
one or more processors being positioned in communication with the one or more databases and being configured to process the formulary data; and
non-transitory memory encoded with one or more computer programs operable by the one or more processors so that during operations thereof, the one or more processors being operable to perform the following steps:
determining the patient's health insurance provider's payment coverage of the prescription drug; wherein:
   if payment coverage is approved, providing the prescription drug to the patient at a first price; and
   if payment coverage is denied, providing the prescription drug at an alternative price.

### DETAILED DESCRIPTION

### Abbreviations and Definitions

To facilitate understanding of the disclosure, a number of terms and abbreviations as used herein are defined below as follows:

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “and/or” when used in a list of two or more items, means that any one of the listed items can be employed by itself or in combination with any one or more of the listed items. For example, the expression “A and/or B” is intended to mean either or both of A and B, i.e. A alone, B alone or A and B in combination. The expression “A, B and/or C” is intended to mean A alone, B alone, C alone, A and B in combination, A and C in combination, B and C in combination or A, B, and C in combination.

The term “adverse response” relates to an unfavorable response not in line with the therapeutic goals of a given drug therapy. It may include any effects from mild to severe, such as, but not limited to, increased discomfort or pain, side effects, such as fever, disproportionate weight loss or weight gain, reduced or impaired metabolic function, cardiovascular function, renal function, neurological function, immunological function, disease recurrence or prolongation and death.

As used herein, the term “contraindicated” refers to any condition in a patient that renders a particular line of treatment, including the administration of one or more drugs, undesirable or improper. Thus, contraindicated drugs include, for example, teratogenic drugs whose administration, for example, to pregnant patients is avoided due to the risks to the fetus. One of ordinary skill in the art could identify examples of treatment that may be contraindicated based upon a patient's age, sex, and health conditions.

The term “prescription drug” refers to FDA (Food and Drug Administration) approved medication that requires a prescription from a licensed medical doctor to purchase.

The term “insurance provider”, as used herein, may include a company in the business of selling and administering insurance policies to individuals and/or other companies, including WC policies. In some embodiments, an insurance provider is also responsible for investigating claims under an insurance policy, determining the benefits (if any) to be paid out for such a claim and/or paying out or otherwise providing such benefits. In some embodiments, one or more functions of an insurance provider may be carried out by a Third Party Administrator, which may be affiliated with an insurance provider and/or a policyholder. It should be understood that wherever the term “insurance provider” is used herein, the term “Third Party Administrator” or “TPA” might be substituted without departing from the spirit and scope of the embodiments.

The terms “coverage” or “cover” are used to refer to the financial liability of a third party payer for health care provided to a beneficiary. There can be varying levels of coverage. A third party payer can be liable for the entire value of health care provided to a beneficiary or only for a portion of the entire value.

The term “benefit” is used to refer to the type of coverage offered to a beneficiary. A health plan, such as a health insurance plan, typically offers a pharmacy benefit (which includes coverage for drugs, prescriptive devices and related products) and a medical benefit (which includes coverage for doctors' visits, emergency room visits and all other medical services and products.

The terms “health insurance”, “health care plan”, or “benefit plan” refer to an insurance plan that pays benefits to an insured in the event that the insured incurs covered medical costs.

The term “coinsurance” refers to insurance that is provided by two different parties to spread the risk of insurance among multiple parties. For example, patients with coinsurance may pay a percent of the direct cost of their prescription medicine.

The phrases “out-of-pocket price”, “out-of-pocket costs”, “out-of-pocket expenses”, the abbreviation “OOP”, or the like refer to the portion of an insurance claim that an insured must pay directly.

The term “cost” refers to the sale price of a particular item in question, such as a pharmacy script.

The terms “copayment” or “copay” refer to the out-of-pocket expense, with a specific dollar amount determined beforehand, that the insured patient pays when a service is rendered.

The term “DUEXIS” refers to the prescription oral dosage combination of ibuprofen and famotidine. It is indicated for the relief of signs and symptoms of rheumatoid arthritis and osteoarthritis and to decrease the risk of developing upper gastrointestinal ulcers.

The term “RAYOS” refers to the prescription delayed release oral dosage of prednisone. It is indicated for the control of severe or incapacitating allergic conditions, dermatologic diseases, endocrine conditions, gastrointestinal diseases, hematologic diseases, neoplastic conditions, nervous system conditions, and ophthalmic conditions, conditions related to organ transplantation, pulmonary diseases, renal conditions, rheumatologic conditions, and specific infectious diseases.

The term “formulary” refers to a list of drugs covered by a managed care plan.

The terms “script”, “prescription”, “pharmacy script” and the like refer to an order for a given quantity of a given drug.

The term “pharmacy” refers to a dispensary where medications are stored and dispensed. They receive requests for prescription drugs, process the requests—including determining if a requested drug is covered by a patient's insurer, and provide the requested drug to the patient. They may operate as standalone community stores within retail shopping areas, or in hospitals and clinics. Prescription drug requests may be made in person, via telephone or the Internet by the patient, or the patient's physician. The prescription drugs may be provided at the pharmacy, or delivered to the patient or family member's home, business, and the like.

Online pharmacies, internet pharmacies, or mail order pharmacies are pharmacies that receive requests for prescription drugs over the Internet and send the orders to customers through the mail or shipping companies.

The term “pharmacy benefits plan” or the like refers to an insurance plan that provides benefits prescription and other drug costs. A pharmacy benefits plan may be a subset of a given health insurance plan. A pharmacy benefits plan may also be a stand-alone insurance policy term.

The term “discount” refers to the amount of price reduction from the original manufacturer's suggested selling price. Discounts may encompass rebates as well.

The term “insured” or “subscriber” refers to one or more persons who purchase and/or are covered by an insurance policy, such as a health insurance policy.

The term “commercial insurance” refers to a health insurance policy that is sold and administered by a non-governmental entity. These entities allow out-of-pocket cost discounts and rebates.

The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Methods

Provided is a method for processing and providing an out-of-pocket price discount for a prescription drug request for a patient in need thereof, comprising the steps of:
receiving the patient's prescription drug request;
determining the patient's health insurance provider's payment coverage of the prescription drug; wherein:
   if payment coverage is approved, providing the prescription drug to the patient at a first price; and
   if payment coverage is denied, providing the prescription drug at an alternative price.

A pharmacy may receive and process a patient's prescription drug request. The process may include determining the patient's health insurance provider, and whether the provider is a commercial or government entity; and determining if the patient's health insurance provider will cover the requested drug. This may include identifying the provider's formulary and pharmacy cost coverage benefits, and deciding if the provider provides or denies a cost coverage benefit for the requested drug. A provider may deny benefits for a number of reasons, such as requiring a generic substitution for a requested name-brand drug, or simply requiring the prescription be filled with a benefit provider's preferred drug. If a provider denies benefits to a patient, that patient can still purchase the prescription at the listed cash price plus a pharmacy markup, which is typically cost-prohibitive.

The pharmacy may determine the out-of-pocket cost or price the patient must pay for the prescription based on the preceding inquiries. If the patient's benefit provider provides coverage of the drug, the drug is provided at an out-of-pocket price determined by the benefit provider. This out-of-pocket price may include a patient's co-pay, deductible, or other cost rules determined by the insurer. The patient's benefit provider pays the remainder of the drug's cost.

If the patient's benefit provider denies coverage of the drug, the patient can still purchase the prescription at the listed cash price plus a pharmacy markup, which is typically cost prohibitive. The drug manufacturer determines the out-of-pocket price for the patient. It is equal to the cost of the drug, plus the pharmacy's markup, less any reimbursement or rebate provided by the drug manufacturer. The pharmaceutical company provides reimbursement to the pharmacy to offset the patient's high out-of-pocket cost for purchasing a drug outside the insurer's formulary, and to remove price as a barrier to purchasing the drug. The alternate price is less than the drug's full retail price. This alternate out-of-pocket price may be more, less or the same as the out-of-pocket price of the drug for patients having insurance coverage for the drug's cost.

In some embodiments, the prescription drug is DUEXIS.

In some embodiments, the prescription drug is RAYOS.

In some embodiments, the method further comprises the step of submitting the patient's prescription drug request. The patient, patient's physician, or a family member and/or caretaker may submit the prescription.

In some embodiments, the patient's physician submits the prescription drug request.

In certain embodiments, the patient's physician submits the prescription drug request electronically. In certain embodiments, the patient submits the prescription drug request.

In some embodiments, the patient's health insurance provider is commercial.

In some embodiments, the method further comprises the step of confirming the prescription drug request with the patient. The pharmacy may communicate with patient in person, or electronically. The patient may confirm the prescription request, any insurance benefit or denial, and willingness to purchase the drug at a determined out-of-pocket price.

In some embodiments, the method further comprises the step of providing the requested prescription drug to the patient.

In certain embodiments, the patient is provided the requested prescription drug at a pharmacy. In certain embodiments, the patient is provided the requested prescription drug at their home.

In certain embodiments, determining comprises comparing, by at least one computer processor, the prescription drug request to the patient's health insurance provider's formulary.

In certain embodiments, wherein if payment coverage is denied, the method includes:
receiving at least one reason for denial from the patient's health insurance provider;
determining if the at least one reason for denial is a risk for an adverse response from utilizing the prescription drug; wherein if there is risk for an adverse response from utilizing the prescription drug, the prescription drug is not provided.

Alternatively, in certain embodiments, the method includes:
receiving at least one reason for denial from the patient's health insurance provider;
determining if the at least one reason for denial is a risk for an adverse response from utilizing the prescription drug; wherein if there is risk for an adverse response from utilizing the prescription drug, the prescription drug is not provided.

In particular embodiments, the risk for an adverse response from utilizing the prescription drug is chosen from dosage, drug interactions, and the patient's preexisting conditions, age, and sex.

In particular embodiments, determining comprises comparing, by at least one computer processor, a pharmacy rejection code provided by the health insurance provider to a database comprising the pharmacy rejection codes and their definitions.

### Media

Provided is a non-transitory, machine-readable medium that stores instructions, which when performed by a machine, cause the machine to perform operations comprising the steps of:
receiving a patient's prescription drug request wherein the prescription drug is to be provided to the patient at a first price;
determining if the patient's health insurance provider denies payment coverage of the prescription drug;
if payment coverage is approved, providing the prescription drug to the patient at that first price; and
if payment coverage is denied, provide the prescription drug at an alternative price.

In some embodiments, the prescription drug is DUEXIS.

In some embodiments, the prescription drug is RAYOS.

In some embodiments, the instructions further comprise the step of submitting the patient's prescription drug request. The patient, patient's physician, or a family member and/or caretaker may submit the prescription.

In some embodiments, the patient's physician submits the prescription drug request.

In certain embodiments, the patient's physician submits the prescription drug request electronically. In certain embodiments, the patient submits the prescription drug request.

In some embodiments, the patient's health insurance provider is commercial.

In some embodiments, the method further comprises the step of confirming the prescription drug request with the patient. The pharmacy may communicate with patient in person, or electronically. The patient may confirm the prescription request, any insurance benefit or denial, and willingness to purchase the drug at a determined out-of-pocket price.

In some embodiments, the instructions further comprise the step of providing the requested prescription drug to the patient.

In certain embodiments, the patient is provided the requested prescription drug at a pharmacy. In certain embodiments, the patient is provided the requested prescription drug at their home.

In certain embodiments, determining comprises comparing, by at least one computer processor, the prescription drug request to the patient's health insurance provider's formulary.

In certain embodiments, wherein if payment coverage is denied, the instructions further include:
receiving at least one reason for denial from the patient's health insurance provider;
determining if the at least one reason for denial is a risk for an adverse response from utilizing the prescription drug; wherein if there is risk for an adverse response from utilizing the prescription drug, the prescription drug is not provided.

Alternatively, in certain embodiments, the instructions further include:
receiving at least one reason for denial from the patient's health insurance provider;
determining if the at least one reason for denial is a risk for an adverse response from utilizing the prescription drug; wherein if there is risk for an adverse response from utilizing the prescription drug, the prescription drug is not provided.

In particular embodiments, the risk for an adverse response from utilizing the prescription drug is chosen from dosage, drug interactions, and the patient's preexisting conditions, age, and sex.

In particular embodiments, determining comprises comparing, by at least one computer processor, a pharmacy rejection code provided by the health insurance provider to a database comprising the pharmacy rejection codes and their definitions.

### Systems

Provided is a system for processing and providing an out-of-pocket price discount for a prescription drug request for a patient in need thereof, comprising:
an interface for receiving the patient's prescription drug request;
one or more databases having formulary data for one or more health insurance providers;
one or more processors being positioned in communication with the one or more databases and being configured to process the formulary data; and
non-transitory memory encoded with one or more computer programs operable by the one or more processors so that during operations thereof, the one or more processors being operable to perform the following steps:
   determining the patient's health insurance provider's payment coverage of the prescription drug; wherein:
      if payment coverage is approved, providing the prescription drug to the patient at a first price; and
      if payment coverage is denied, providing the prescription drug at an alternative price.

In some embodiments, the prescription drug is DUEXIS.

In some embodiments, the prescription drug is RAYOS.

In some embodiments, the operations include the step of submitting the patient's prescription drug request. The patient, patient's physician, or a family member and/or caretaker may submit the prescription.

In some embodiments, the patient's physician submits the prescription drug request.

In certain embodiments, the patient's physician submits the prescription drug request electronically. In certain embodiments, the patient submits the prescription drug request.

In some embodiments, the patient's health insurance provider is commercial.

In some embodiments, the operations comprise the step of confirming the prescription drug request with the patient. The pharmacy may communicate with patient in person, or electronically. The patient may confirm the prescription request, any insurance benefit or denial, and willingness to purchase the drug at a determined out-of-pocket price.

In some embodiments, the operations further comprise the step of providing the requested prescription drug to the patient.

In certain embodiments, the patient is provided the requested prescription drug at a pharmacy. In certain embodiments, the patient is provided the requested prescription drug at their home.

In certain embodiments, determining comprises comparing, by at least one computer processor, the prescription drug request to the patient's health insurance provider's formulary.

In certain embodiments, wherein if payment coverage is denied, the operations include:
receiving at least one reason for denial from the patient's health insurance provider;
determining if the at least one reason for denial is a risk for an adverse response from utilizing the prescription drug; wherein if there is risk for an adverse response from utilizing the prescription drug, the prescription drug is not provided.

Alternatively, in certain embodiments, the operations include:
receiving at least one reason for denial from the patient's health insurance provider;
determining if the at least one reason for denial is a risk for an adverse response from utilizing the prescription drug; wherein if there is risk for an adverse response from utilizing the prescription drug, the prescription drug is not provided.

In particular embodiments, the risk for an adverse response from utilizing the prescription drug is chosen from dosage, drug interactions, and the patient's preexisting conditions, age, and sex.

In particular embodiments, determining comprises comparing, by at least one computer processor, a pharmacy rejection code provided by the health insurance provider to a database comprising the pharmacy rejection codes and their definitions.

### Example

A medical patient is prescribed a prescription drug by their physician. The physician (or their staff) electronically sends the prescription to a pharmacy. The pharmacy determines if the patient's health insurance provider provides payment coverage of the prescription drug. The pharmacy may receive this communication in the form of rejection codes—numbered codes that correspond to drug request rejections. A partial list is provided below.

TABLE 1
Pharmacy Reject Codes

| NCPDP | | EDIT/EOB | |
|---|---|---|---|
| CODE | DESCRIPTION | CODE | DESCRIPTION |
| 01 | M/I Bin | | |
| 02 | M/I Version Number | | |
| 03 | M/I Transaction Code | | |
| 04 | M/I Processor Control Number | | |
| 05 | M/I Pharmacy Number | 8029 | Claim denied. Provider number is missing or |
| | | | invalid. |
| 06 | M/I Group Number | | |
| 07 | M/I Cardholder Identification | 2006 | Client number missing or invalid. |
| | Number | | |
| 08 | M/I Person Code | | |
| 09 | M/I Birthdate | GA = 1005 | Client DOB is missing or an invalid date format |
| | | | on the GA claim. |
| 10 | M/I Sex Code | GA = 1004 | Client gender code is missing or not a valid |
| | | | value on the GA claim. |
| 11 | M/I Relationship Code | | |
| 12 | M/I Customer Location Code | 8114 | Dispense location code is missing or not a valid |
| | | | code. |
| 13 | M/I Other Coverage Code | 8095 | Other insurance/indicator/carrier code is |
| | | | missing or not a valid code. |
| 14 | M/I Eligibility Override Code | | |
| 15 | M/I Date Filled | 8119 | The date dispensed is missing or invalid. |
| 16 | M/I Rx Number | 8118 | Prescription number is missing. |
| 17 | M/I New-Refill Code | 8115 | The refill indicator is missing or invalid. |
| 18 | M/I Metric Quantity | 8122 | The quantity dispensed is missing or invalid. |
| 19 | M/I Days Supply | 8123 | The estimated days supply is missing or invalid. |
| 20 | M/I Compound Code | | |
| 21 | M/I NDC Number | 8120 | The NDC is missing or invalid. |
| 22 | M/I Dispensed As Written Code | | |
| 23 | M/I Ingredient Cost | | |
| 24 | M/I Sales Tax | | |
| 25 | M/I Prescriber Identification | 8126 | The prescribing practitioner number is |
| | | | missing or invalid. |
| 26 | Future Use | | |
| 27 | Future Use | | |
| 28 | M/I Date Rx Written | | |
| 29 | M/I # Refills Authorized | | |
| 30 | M/I PA/MC Code and Number | | |
| 31 | Future Use | | |
| 32 | M/I Level of Service | | |
| 33 | M/I RX Origin Code | | |
| 34 | M/I RX Denial Override Code | | |
| 35 | M/I Primary Prescriber | | |
| 36 | M/I Clinic Identification | | |
| 37 | Future Use | | |
| 38 | M/I Basis of Cost | | |
| 39 | M/I Diagnosis Code | 8128 | NDC requires diagnosis code. |
| 40 | Pharmacy Not Contracted with Plan | 8082 | Claim denied. Provider ineligible on date(s) of |
| | on Date of Service | | service. |
| 41 | Submit Bill to Other Processor or | | |
| | Primary Payor | | |
| 42 | Future Use | | |
| 43 | Future Use | | |
| 44 | Future Use | | |
| 45 | Future Use | | |
| 46 | Future Use | | |
| 47 | Future Use | | |
| 48 | Future Use | | |
| 49 | Future Use | | |
| 50 | Non-Matched Pharmacy Number | 8187 | Provider number not on file. |
| 51 | Non-Matched Group Number | | |
| 52 | Non-Matched Cardholder | 2004 | The client number is not on file. |
| | Identification | | |
| 53 | Non-Matched Person Code | | |
| 54 | Non-Matched NDC Number | 8121 | The NDC billed is not on file. |
| 55 | Non-Matched NDC Package Size | | |
| 56 | Non-Matched Prescriber | 8246 | Prescribing practitioner is not on file. |
| | Identification | | |
| 57 | Non-Matched PA/MC Number | | |
| 58 | Non-Matched Primary Prescriber | 8246 | Prescribing practitioner is not on file. |
| 59 | Non-Matched Clinic Identification | | |
| 60 | Drug Not Covered For Patient Age | 8157 | This NDC is not consistent with client's age. |
| 61 | Drug Not Covered For Patient | 8156 | This NDC is not consistent with client's |
| | Gender | | gender. |
| 62 | Patient/Card Holder ID Name | 2002 | The client's name on claim is not consistent |
| | Mismatch | | with the client's number. |
| 63 | Institutionalized Patient. NDC | 8133 | Claim denied. Drugs/devices are included in |
| | Not Covered | | the Nursing Facility per diem rate. |
| 64 | Claim Submitted Does Not Match | | |
| | Prior Authorization | | |
| 65 | Patient is Not Covered | 2000 | Client ineligible for dates of service. |
| 66 | Patient Age Exceeds Maximum Age | 8157 | This NDC is not consistent with the client's age. |
| 67 | Filled Before Coverage Effective | | |
| 68 | Filled After Coverage Expired | | |
| 69 | Filled After Coverage Terminated | | |
| 70 | NDC Not Covered | 8053 | NDC is not covered for this client on this date |
| | | 8092 | of service—Policy Restriction. |
| | | 8127 | NDC is not covered for this client on this date |
| | | 8178 | of service—OTC. |
| | | | NDC is not covered on the dispense date. NDC |
| | | | is not covered. |
| 71 | Prescriber is Not Covered | | |
| 72 | Primary Prescriber is Not Covered | | |
| 73 | Refills are Not Covered | | |
| 74 | Other Carrier Payment Meets or | | |
| | Exceeds Payable | | |
| 75 | Prior Authorization Required | 3000 | Prior authorization not found. |
| 76 | Plan Limitations Exceeded | | |
| 77 | Discontinued NDC Number | 8164 | NDC is not covered—terminated drug. |
| 78 | Cost Exceeds Maximum | | |
| 79 | Refill Too Soon | | |
| 80 | Drug Diagnosis Mismatch | 8160 | NDC not covered with this diagnosis code. |
| 81 | Claim Too Old | 8012 | Claim denied. Does not meet timely filing |
| | | | requirements. |
| 82 | Claim is Post Dated | | |
| 83 | Duplicate Paid/Captured Claim | 8008 | Claim denied. Duplicate of a service previously |
| | | | paid. |
| 84 | Claim Has Not Been Paid/Captured | | |
| 85 | Claim Not Processed | | |
| 86 | Submit Manual Reversal | | |
| 87 | Reversal Not Processed | | |
| 88 | DUR Reject Error | | |
| 89 | Rejected Claim Fees Paid | | |
| 90 | Host Hung Up | | |
| 91 | Host Response Error | | |
| 92 | System Unavailable/Host | | |
| | Unavailable | | |
| 93 | Planned Unavailable | | |
| 94 | Invalid Message | | |
| 95 | Time Out | | |
| 96 | Scheduled Downtime | | |
| 97 | Payor Unavailable | | |
| 98 | Connection to Payor is Down | | |
| 99 | Host Processing Error | | |
| CA | M/I Patient's First Name | 2007 | Client's name is missing or invalid. Client name |
| | | GA = 1003 | is missing from GA claim. |
| CB | M/I Patient's Last Name | 2007 | Client's name is missing or invalid. Client name |
| | | GA = 1003 | is missing from GA claim. |
| CC | M/I Cardholder First Name | | |
| CD | M/I Cardholder Last Name | | |
| CE | M/I Home Plan | | |
| CF | M/I Employer Name | | |
| CG | M/I Employer Street Address | | |
| CH | M/I Employer City Address | | |
| CI | M/I Employer State Address | | |
| CJ | M/I Employer Zip Code | | |
| CK | M/I Employer Phone Number | | |
| CL | M/I Employer Contact Name | | |
| CM | M/I Patient Street Address | | |
| CN | M/I Patient City Address | | |
| CO | M/I Patient State Address | | |
| CP | M/I Patient Zip Code | | |
| CQ | M/I Patient Phone Number | | |
| CR | M/I Carrier Identification Number | | |
| CT | M/I Patient Social Security Number | GA = 1007 | Client SSN is missing or invalid on the GA |
| | | | claim. |
| DP | M/I Drug Type Override | | |
| DQ | M/I Usual and Customary | Compound = | Billed amount is missing or invalid. |
| | | 8009 | Claim submitted without services billed. |
| | | 8021 | |
| DR | M/I Doctors Last Name | | |
| DS | M/I Postage Amount Claimed | | |
| DT | M/I Unit Dose Indicator | | |
| DU | M/I Gross Amount Due | | |
| DV | M/I Other Payor Amount | 8095 | Other insurance amount/indicator/carrier |
| | | | code is missing or invalid. |
| DW | M/I Basis of Days Supply | | |
| | Determination | | |
| DX | M/I Patient Paid Amount | | |
| DY | M/I Date of Injury | | |
| DZ | M/I Claim/Reference ID Number | | |
| E1 | M/I Alternate Product Type | | |
| E2 | M/I Alternate Product Code | | |
| E3 | M/I Incentive Amount Submitted | | |
| E4 | M/I DUR Conflict Code | | |
| E5 | M/I DUR Intervention Code | | |
| E6 | M/I DUR Outcome Code | | |
| E7 | M/I Metric Decimal Quantity | | |
| E8 | M/I Other Payor Date | | |
| M1 | Patient Not Covered in This Aid | | |
| | Category | | |
| M2 | Recipient Locked In | 2011 | Client locked-in to another provider. This |
| | | | service not payable. |
| M3 | Host PA/MC Error | | |
| M4 | RX Number/Time Limit Exceeded | 8117 | Exceeds maximum refills allowed. |
| M5 | Requires Manual Claim | | |
| M6 | Host Eligibility Error | | |
| M7 | Host Drug File Error | | |
| M8 | Host Provider File Error | | |
| MZ | Error Overflow | | |

The insurance provider could approve coverage, or deny coverage for any number of reasons. The insurance provider deny coverage for missing, invalid, or inconsistent information in the request; or because the drug is contraindicated for the patient. However, if the patient is denied coverage because the drug is not included on the formulary for their insurance plan, the pharmacy, using a specific set of codes & instructions, offers the prescription to the patient at a lower out of pocket price. For example, the prescription may be offered at a price of $20 instead of $750. The pharmacist at the pharmacy contacts the patient, takes payment, and provides the prescription. The requested prescription may be delivered in person, mail or parcel post.

It should also be apparent that the steps may be performed in any order, and that some steps may be omitted.

The detailed description set-forth above is provided to aid those skilled in the art in practicing the present disclosure. However, the disclosure described and claimed herein is not to be limited in scope by the specific embodiments herein disclosed because these embodiments are intended as illustration of several aspects of the disclosure. Any equivalent embodiments are intended to be within the scope of this disclosure. Indeed, various modifications of the disclosure in addition to those shown and described herein will become apparent to those skilled in the art from the foregoing description, which do not depart from the spirit or scope of the present inventive discovery. Such modifications are also intended to fall within the scope of the appended claims.

What is claimed is:

1. A method for processing and providing an out-of-pocket price discount for a prescription drug request for a patient in need thereof, comprising the steps of:
a. receiving the patient's prescription drug request;
b. determining the patient's health insurance provider's payment coverage of the prescription drug; wherein:
i. if payment coverage is approved, providing the prescription drug to the patient at a first price; and
ii. if payment coverage is denied, providing the prescription drug at an alternative price.

2. The method of claim 1, wherein the prescription drug is DUEXIS.

3. The method of claim 1, wherein the prescription drug is RAYOS.

4. The method of claim 1, wherein the patient's health insurance provider is commercial.

5. The method of claim 1, further comprising the step of submitting the patient's prescription drug request.

6. The method of claim 5, wherein the patient's physician submits the prescription drug request.

7. The method of claim 5, wherein the patient's physician submits the prescription drug request electronically.

8. The method of claim 5, wherein the patient submits the prescription drug request.

9. The method of claim 1, further comprising the step of confirming the prescription drug request with the patient.

10. The method of claim 1, wherein the patient is provided the requested prescription drug at a pharmacy.

11. The method of claim 1, wherein the patient is provided the requested prescription drug at their home.

12. The method of claim 1, wherein determining comprises comparing, by at least one computer processor, the prescription drug request to the patient's health insurance provider's formulary.

13. The method of claim 1, wherein if payment coverage is denied,
a. receiving at least one reason for denial from the patient's health insurance provider;
b. determining if the at least one reason for denial is a risk for an adverse response from utilizing the prescription drug; wherein if there is risk for an adverse response from utilizing the prescription drug, the prescription drug is not provided.

14. The method of claim 1, wherein if payment coverage is denied,
a. receiving at least one reason for denial from the patient's health insurance provider;
b. determining if the at least one reason for denial is missing, erroneous, invalid, or inconsistent information in the prescription drug request; wherein if there is missing, erroneous, invalid, or inconsistent information in the prescription drug request, the prescription drug is not provided.

15. The method of claim 13, wherein the risk for an adverse response from utilizing the prescription drug is chosen from dosage, drug interactions, and the patient's preexisting conditions, age, and sex.

16. The method of claim 13, wherein determining comprises comparing, by at least one computer processor, a pharmacy rejection code provided by the health insurance provider to a database comprising the pharmacy rejection codes and their definitions.

17. A non-transitory, machine-readable medium that stores instructions, which when performed by a machine, cause the machine to perform operations comprising the steps of:
a. receiving a patient's prescription drug request;
b. determining the patient's health insurance provider's payment coverage of the prescription drug; wherein:
i. if payment coverage is approved, providing the prescription drug to the patient at a first price; and
ii. if payment coverage is denied, providing the prescription drug at an alternative price.

18. The non-transitory, machine-readable medium of claim 17, wherein the prescription drug is DUEXIS.

19. The non-transitory, machine-readable medium of claim 17, wherein the prescription drug is RAYOS.

20. The non-transitory, machine-readable medium of claim 17, wherein the patient's health insurance provider is commercial.

21. The non-transitory, machine-readable medium of claim 17, further comprising the step of submitting the patient's prescription drug request.

22. The non-transitory, machine-readable medium of claim 21, wherein the patient's physician submits the prescription drug request.

23. The non-transitory, machine-readable medium of claim 22, wherein the patient's physician submits the prescription drug request electronically.

24. The non-transitory, machine-readable medium of claim 21, wherein the patient submits the prescription drug request.

25. The non-transitory, machine-readable medium of claim 17, further comprising the step of confirming the prescription drug request with the patient.

26. The non-transitory, machine-readable medium of claim 17, wherein the patient is provided the requested prescription drug at a pharmacy.

27. The non-transitory, machine-readable medium of claim 17, wherein the patient is provided the requested prescription drug at their home.

28. The non-transitory, machine-readable medium of claim 17, wherein determining comprises comparing, by at least one computer processor, the prescription drug request to the patient's health insurance provider's formulary.

29. The non-transitory, machine-readable medium of claim 17, wherein if payment coverage is denied,
a. receiving at least one reason for denial from the patient's health insurance provider;
b. determining if the at least one reason for denial is a risk for an adverse response from utilizing the prescription drug; wherein if there is risk for an adverse response from utilizing the prescription drug, the prescription drug is not provided.

30. The non-transitory, machine-readable medium of claim 17, wherein if payment coverage is denied,
a. receiving at least one reason for denial from the patient's health insurance provider;
b. determining if the at least one reason for denial is missing, erroneous, invalid, or inconsistent information in the prescription drug request; wherein if there is missing, erroneous, invalid, or inconsistent information in the prescription drug request, the prescription drug is not provided.

31. The non-transitory, machine-readable medium of claim 29, wherein the risk for an adverse response from utilizing the prescription drug is chosen from dosage, drug interactions, and the patient's preexisting conditions, age, and sex.

32. The non-transitory, machine-readable medium of claim 29, wherein determining comprises comparing, by at least one computer processor, a pharmacy rejection code provided by the health insurance provider to a database comprising the pharmacy rejection codes and their definitions.

33. A system for processing and providing an out-of-pocket price discount for a prescription drug request for a patient in need thereof, comprising:
a. an interface for receiving the patient's prescription drug request;
b. one or more databases having formulary data for one or more health insurance providers;
c. one or more processors being positioned in communication with the one or more databases and being configured to process the formulary data; and
d. non-transitory memory encoded with one or more computer programs operable by the one or more processors so that during operations thereof, the one or more processors being operable to perform the following steps:
i. determining the patient's health insurance provider's payment coverage of the prescription drug; wherein:
(i) if payment coverage is approved, providing the prescription drug to the patient at a first price; and
(ii) if payment coverage is denied, providing the prescription drug at an alternative price.

34. The system of claim 33, wherein the prescription drug is DUEXIS.

35. The system of claim 33, wherein the prescription drug is RAYOS.

36. The system of claim 33, wherein the patient's health insurance provider is commercial.

37. The system of claim 33, further comprising the step of submitting the patient's prescription drug request.

38. The system of claim 37, wherein the patient's physician submits the prescription drug request.

39. The system of claim 38, wherein the patient's physician submits the prescription drug request electronically.

40. The system of claim 37, wherein the patient submits the prescription drug request.

41. The system of claim 33, further comprising the step of confirming the prescription drug request with the patient.

42. The system of claim 33, wherein the patient is provided the requested prescription drug at a pharmacy.

43. The system of claim 33, wherein the patient is provided the requested prescription drug at their home.

44. The system of claim 33, wherein determining comprises comparing, by at least one computer processor, the prescription drug request to the patient's health insurance provider's formulary.

45. The system of claim 33, wherein if payment coverage is denied,
a. receiving at least one reason for denial from the patient's health insurance provider;
b. determining if the at least one reason for denial is a risk for an adverse response from utilizing the prescription drug; wherein if there is risk for an adverse response from utilizing the prescription drug, the prescription drug is not provided.

46. The system of claim 33, wherein if payment coverage is denied,
a. receiving at least one reason for denial from the patient's health insurance provider;
b. determining if the at least one reason for denial is missing, erroneous, invalid, or inconsistent information in the prescription drug request; wherein if there is missing, erroneous, invalid, or inconsistent information in the prescription drug request, the prescription drug is not provided.

47. The system of claim 45, wherein the risk for an adverse response from utilizing the prescription drug is chosen from dosage, drug interactions, and the patient's preexisting conditions, age, and sex.

48. The system of claim 45, wherein determining comprises comparing, by at least one computer processor, a pharmacy rejection code provided by the health insurance provider to a database comprising the pharmacy rejection codes and their definitions.
